(19) United States
(12) Patent Application Publication
(10) Pub. No.: US 2022/0129595 A1
(43) Pub. Date: Apr. 28, 2022

(54) DESIGN AND OPTIMIZATION METHOD OF POROUS STRUCTURE FOR 3D HEAT DISSIPATION BASED ON TRIPLY PERIODIC MINIMAL SURFACE (TPMS)

(71) Applicant: DALIAN UNIVERSITY OF TECHNOLOGY, Dalian, Liaoning (CN)

(72) Inventors: Shengfa WANG, Dalian, Liaoning (CN); Yu JIANG, Dalian, Liaoning (CN); Baojun LI, Dalian, Liaoning (CN); Yi WANG, Dalian, Liaoning (CN); Fengqi LI, Dalian, Liaoning (CN); Zhongxuan LUO, Dalian, Liaoning (CN)

(21) Appl. No.: 17/291,566

(22) PCT Filed: Jun. 28, 2020
(86) PCT No.: PCT/CN2020/098549

§ 371 Date: May 5, 2021

(51) Int. Cl. G06F 30/10

(52) U.S. Cl. CPC G06F 30/10; G06F 2111/10

(57) ABSTRACT

A design and optimization method of a porous structure for 3D heat dissipation based on triply periodic minimal surface (TPMS) belongs to the field of computer-aided design. Firstly, a porous structure is established through implicit function presentation of TPMS. Secondly, a heat dissipation problem is converted into a minimization problem of thermal compliance under given constraints according to a steady-state heat conduction equation. Then, parametric functions are directly computed through a global-local interpolation method. Finally, period optimization and wall-thickness optimization are conducted for a modeling problem to obtain an optimized porous shell structure with smooth period and wall-thickness change. The porous structure of the present invention greatly improves the heat dissipation performance, and efficiency and effectiveness of heat conduction. The porous structure designed by the present invention has the characteristics of smoothness, full connectivity, controllability and quasi-self-supporting. These characteristics ensure the applicability and the manufacturability of this structure.

### TECHNICAL FIELD

The present invention belongs to the field of engineering design and manufacture, relates to a design and optimization method of a porous structure for 3D heat dissipation, and is suitable for heat dissipation structures of all kinds of large construction machinery, radiators of automobiles and related components of gas appliances.

### BACKGROUND

How to construct lightweight and efficient heat dissipation structures has received extensive attention in various engineering fields. The traditional radiator structure cannot achieve high heat conduction efficiency. The heat conduction performance of the structure can be effectively enhanced through the research on the porous structure. However, presentation and optimization methods become the technical bottlenecks which restrict the further development.

The traditional heat dissipation structure design depends on the basic theories and practical experience of heat, and is difficult to solve the problem of heat dissipation of the complex structure. Subsequently, a topology optimization method using porous structures of tree topology structure, truss/frame structure and microstructure appears to treat the above problems. These porous structures can be used for calculating the high degree of freedom topology of a cooling channel. However, these methods have a common problem that a large number of design variables are required and optimization is expensive due to time-consuming remeshing.

In recent years, the porous structures based on Triply Periodic Minimal Surface (TPMS) have been widely used in the fields of tissue engineering technology, lightweight manufacture and biomedicine. The porous structures based on TPMS have the advantages of good connectivity, easy control and high specific strength and stiffness. It will consume much time and memory to present the porous structures based on TPMS (especially large complicated porous structures) with polyhedral mesh (tetrahedron or hexahedron); and almost all of the traditional treatment methods for porous structures based on finite element are heuristic and not effectively optimized. Therefore, there are few studies on heat dissipation of the porous structures based on TPMS.

Based on the above purpose, an effective presentation and optimization method is proposed to obtain the period and wall-thickness of a porous shell structure based on TPMS suitable for heat dissipation. The main optimization process comprises period optimization and wall-thickness optimization. The former is coarse adjustment of the structure, and the latter is fine adjustment of the structure. Firstly, the porous shell structure is presented by an implicit function, and the implicit function is controlled by a periodic parametric function and a wall-thickness parametric function. On this basis, a steady-state heat conduction equation with boundary conditions can be conveniently established as a mathematical model by using the functional expression. Then, the optimization problem of the model is converted to computing the above two continuous parametric functions. Finally, from the perspective of discretization, the two parametric functions can be effectively calculated by implicit function presentation and radial basis function (RBF) interpolation without remeshing, thereby obtaining an optimized porous structure for heat dissipation with smooth period and wall-thickness change.

### SUMMARY

The present invention proposes an effective presentation and optimization method of a porous structure for heat dissipation based on triply periodic minimal surface (TPMS). Firstly, a porous structure is established through implicit function presentation of TPMS. Secondly, the heat dissipation problem is converted into a minimization problem of thermal compliance under given constraints according to a steady-state heat conduction equation. Then, the parametric functions are directly computed through a global-local interpolation method. Finally, period optimization and wall-thickness optimization are conducted for the modeling problem to obtain an optimized porous shell structure with smooth period and wall-thickness change.

The present invention adopts the following technical solution:

A design and optimization method of a porous structure for 3D heat dissipation based on triply periodic minimal surface (TPMS) is as follows:

(I) Presentation of the Porous Structure

Most of the frequently-used TPMSs have implicit function presentation, and P-TPMS is taken as an example:

φₚ(r)=cos(2πx)+cos(2πy)+cos(2πz)=0 (1.1)

wherein r is a 3D vector and x, y and z are respectively corresponding coordinates.

A period parametric function P(r)>0 can be directly added to function presentation of TPMS. To maintain the value scaling of a signed distance field (SDF) in the process of period change, the implicit function is improved, and presented as:

$${φ}^{0} = P ( r ) \cdot φ ( \frac{r}{P ( r )} ) = 0 \qquad ( 1.2 )$$

wherein P(r) controls the continuous change of a pore period, and a porous surface with smooth transition in space is constructed; other types of TPMSs are processed according to the same method.

A porous structure with thickness based on TPMS can be obtained by offsetting the improved implicit function surface φ⁰ to both sides through the parametric function W(r) controlling the wall-thickness; and two offset surfaces are presented as:

$$\begin{matrix}{φ}^{W} ( r ) = P ( r ) \cdot φ ( \frac{r}{P ( r )} ) - W ( r ) = 0 & ( 1.3 ) \\ {φ}^{- W} ( r ) = P ( r ) \cdot φ ( \frac{r}{P ( r )} ) + W ( r ) = 0 & ( 1.4 )\end{matrix}$$

Finally, a porous shell structure based on TPMS is presented through functions using intersection operator:

Φ(r)=−φ^{W}(r)+φ^{-W}(r)−\sqrt{φ^{W}(r)²+φ^{-W}(r)²} (1.5)

In the above definition, the parametric function P(r)>0 controlling the period and the parametric function W(r)>0 controlling the wall-thickness are introduced to control the shape and period pores of the porous structure, and the porous structure with wall-thickness which satisfies the demands is finally generated through the optimized parametric functions P(r) and W(r).

The porous structure defined by the above functions inherits the good characteristics of TPMS, such as high surface area-to-volume ratio, full connectivity, high smoothness and controllability. High surface-to-volume ratio and full connectivity are conducive to heat dissipation of the structure. The structure functions provide a computable optimization method based on high controllability of the period and the wall-thickness. Good smoothness and connectivity are conducive to 3D printing manufacturing to ensure the accuracy of manufacturing, and excess material (such as excess liquid in SLA) can be removed during 3D manufacturing.

(II) Optimization Process of Heat Dissipation Problem

The present invention mainly focuses on the heat dissipation problem under steady-state heat conduction conditions, fills the internal space of the model by the constructed porous shell structure after the thermal source and boundary conditions of the model are given, and calculates the optimized distribution of the period and wall-thickness of the porous structure under the given volume constraint of the material and the gradient constraint of the period function.

1. Establishment of Problem Model

Based on the above purpose, a heat dissipation problem model is established as follows:

$${min}_{P ( r ) , W ( r )} C = {\int }_{{Γ}_{Q}} H ( Φ ) {q}_{s} Td Γ + {\int }_{Ω} QTd Ω \qquad ( 1.6 )$$

Then:

∫_{Ω}H(Φ)λ∇T∇ωdΩ=∫_{Γ}_{_{Q}}H(Φ)ω^{T}qₛdΓ+ω^{T}QdΩ+∫_{Γ}_{_{T}}λ∇T̅ωdΓ, (1.7)

V=∫H(Φ)dΩ≤v̅, (1.8)

∥∇P(r)∥g̅, (1.9)

wherein C is thermal compliance, T is a temperature field, Ω is a given design domain, Φ is the function presentation of the porous shell structure given above, Q is a heat flux of an internal heat generation term, qₛ is a heat flux along a normal direction on a Neumann boundary Γ_{Q}, T̅ is a given temperature on a Direchlet boundary and λ is material thermal conductivity; ∇ is a vector differential operator,

$$∇ = \frac{\partial }{\partial x} X + \frac{\partial }{\partial y} Y + \frac{\partial }{\partial z} Z ;$$

X, Y and Z respectively present unit vectors along the positive directions of three coordinate axes x, y and z; ω∈ [symbol] is a corresponding test function; [symbol] ={ω|ω∈Sob¹(Ω), ω=0 on Γ_{T}}; Sob¹ is a first-order Sobolev space; V is the volume of the porous structure; v̅ is a corresponding volume constraint; to prevent the severe change of the period function from damaging the porous structure, the gradient constraint g̅ of the period change is added; a computing formula of modules of gradients is

$$∇ P ( r ) = \sqrt{{( \frac{\partial P ( r )}{\partial x} )}^{2} + {( \frac{\partial P ( r )}{\partial y} )}^{2} + {( \frac{\partial P ( r )}{\partial z} )}^{2}} ;$$

H(x) is Heaviside function; when x is negative, H(x)=0, otherwise, is 1; to make the optimization problem differentiable and avoid a check board phenomenon, H(x) is defined as a continuous function H_{η}(x) which is defined as:

$${H}_{η} ( x ) = \{ \begin{matrix}1 , & if x > η , \\ \frac{3}{4} ( \frac{x}{η} - \frac{{x}^{3}}{3 {η}^{3}} ) + \frac{1}{2} , & if - η \leq x \leq η , \\ 0 , & if x < - η ,\end{matrix} \qquad ( 1.10 )$$

wherein η is a regularization parameter used for controlling the number of non-singularity elements in a global stiffness matrix, and the interval of intermediate values is generally defined by the parameter η=10⁻³. In addition, the material thermal conductivity λ of the porous structure is calculated by the structure function Φ, and shall be set as

$$λ = \frac{{λ}_{S} \cdot {λ}_{D}}{ξ \cdot ( {λ}_{D} - {λ}_{S} ) + {λ}_{S}} ; ξ = H ( Φ )$$

is the volume ratio of solid material; and λ_{S} and λ_{D} present the material thermal conductivity of the solid material and the pore part respectively.

2. Discretization

A dual-scale mesh is used in the discretization process; the 3D design space of the design domain is firstly divided into uniform hexahedral finite elements, called coarse units; the coarse units are used to generate the temperature field, and the number nₛ of the coarse units is determined by the volume of the design space; then, each coarse unit is further subdivided into smaller hexahedral units, called fine units; the fine units are used for more precise geometric calculation of the volume and the like; and herein, the number n_{b} of the fine units in each coarse unit is set as 27 by default. The discrete form of the optimization problem (1.6-1.9) is obtained:

$$\begin{matrix}min \\ P ( r ) , W ( r )\end{matrix} C = {Q}^{T} T \qquad ( 1.11 )$$

### Then:

$$\begin{matrix}KT = Q & ( 1.12 ) \\ V = \frac{1}{8} {\sum }_{i = 1}^{{N}_{b}} {\sum }_{l = 1}^{8} {H}_{η} ( {Φ}_{l}^{j} ) {v}_{b} \leq \overline{v} , & ( 1.13 ) \\ G = \frac{1}{‖ Ω ‖} {\sum }_{i = 1}^{{n}_{l}} L ( \frac{{( {\sum }_{s = 1}^{{N}_{b}^{i}} {‖ ∇ {P}_{s}^{i} ‖}^{p} )}^{\frac{1}{p}}}{{\overline{g}}_{i}} - 1 ) {v}_{{Ω}_{i}} \leq 0 , & ( 1.14 )\end{matrix}$$

wherein T is the temperature field; Q is the thermal source and heat flux term; K is a stiffness matrix; V is the volume of the porous structure; v̅ is the corresponding volume constraint; N_{b}=n_{b}×nₛ is the total number of the fine units; Φₗ^{j} is the Φ function value of the lth node in the jth fine unit; v_{b} is the volume of fine mesh units; G is the total gradient constraint of the structure; ∥Ω∥ is the volume of Ω; nₗ is the number of sub-domains in the design domain; N_{b}ⁱ is the number of the fine units in the ith sub-domain Ωᵢ; ΔPₛⁱ is the gradient of the period function at the point i in the sth fine unit; g̅ᵢ is a local gradient constraint value in the ith sub-domain Ωᵢ; v_{Ω}_{ᵢ} is the volume of the ith coarse mesh unit; p>0 is the penalty factor of the global gradient constraint, and moreover:

$$L ( x ) = \{ \begin{matrix}{x}^{2} , & if x \geq 0 , \\ 0 , & if x < 0.\end{matrix} \qquad ( 1.15 )$$

3. Global-Local Interpolation

The optimization of the period parametric function and the thickness parametric function is converted into the optimization of a finite number of design variables by using a global-local radial basis function (RBF) interpolation algorithm; and the key idea is to decompose a large coefficient matrix into smaller coefficient matrices with weights for calculation.

By taking the period parametric function as an example, firstly, Ω is divided into nₗ sub-domains {Ωᵢ}ᵢ₌₁ⁿ^{ₗ}, and radial basis function (RBF) interpolation is performed in local ellipsoids (comprising corresponding sub-domains) to obtain a local period parametric function:

$$\begin{matrix}P ( r ) = {\sum }_{k = 1}^{{n}_{l}} \frac{{ω}_{k} ( r )}{{\sum }_{j = 1}^{{n}_{l}} {ω}_{j} ( r )} {P}_{k} ( r ) = {\sum }_{k = 1}^{{n}_{l}} {ψ}_{k} ( r ) {P}_{k} ( r ) , & ( 1.16 ) \\ {ω}_{k} ( r ) = {( \frac{{( {R}_{k} ( r ) - {d}_{k} ( r ) )}_{+}}{{R}_{k} ( r ) \cdot {d}_{k} ( r )} )}^{2} , & ( 1.17 )\end{matrix}$$

wherein ψₖ(r) is a weight parameter defined by ωₖ(r); dₖ(r)=∥r−Cₖ∥₂ is a distance between an interpolation point and an ellipsoid center point Cₖ; (*)₊ is (x)₊=x when a truncation function satisfies x>0, otherwise (x)₊=0; Rₖ(r) is a length function of the radius; Pₖ(r) is the local period parametric function corresponding to the sub-domain Ωₖ in the local ellipsoids and is defined as:

Pₖ(r)=Σᵢ₌₁ⁿ^{ₙₖ}Rₖᵢ(r)aₖᵢ+Σⱼ₌₁^{m}gₖⱼ(r)bₖⱼ, (1.18)

wherein Rₖᵢ(r)=(r−Oₖᵢ)² log(|r−Oₖᵢ|) is a thin plate radial basis function; {Oₖᵢ}ᵢ₌₁ⁿ^{ₖₜ} is a control point corresponding to the sub-domain Ωₖ in the local ellipsoids; qₖᵢ(r) is a primary term of coordinates x, y and z; aₖᵢ and bₖⱼ are undetermined coefficients of a quadratic term and the primary term respectively; and m is the number of the primary terms (m=4 by default).

The global-local RBF interpolation can be simplified as follows:

P(r)=Σᵢ₌₁ⁿ^{ₜ}Nᵢ(r)Pᵢ, (1.19)

wherein nₜ is the total number (generally 400) of control points in the design domain Ω; Nᵢ(r) is a corresponding computable coefficient function; and {Pᵢ}ᵢ₌₁ⁿ^{ₜ} is the period function value of the control points. The proposed global-local interpolation method can increase calculation efficiency and simultaneously makes the structure changed smoothly.

4. Optimization of Modeling Problem

The 3D heat dissipation optimization method proposed based on the above constructed optimization problem comprises two parts of period optimization and wall-thickness optimization. The period and the wall-thickness of the porous structure based on TPMS are independently controlled by the period function P(r) and the wall-thickness function W(r) respectively. The period optimization is coarse adjustment of the structure, and the wall-thickness optimization is fine adjustment. A specific optimization process is as follows:

Step 1: period optimization; firstly, converting the function optimization into the optimization of interpolation basis function parameters through the RBF interpolation method; randomly selecting nₜ interpolation basis points {Oᵢ}ᵢ₌₁ⁿ^{ₜ} from a solution domain, and then obtaining an interpolation form:

P(r)=Σᵢ₌₁ⁿ^{ₜ}Nᵢ(r)Pᵢ, (1.20)

thus, converting the problem of period optimization into the problem of optimization of the parametric variable {Pᵢ}ᵢ₌₁ⁿ^{ₜ}; finally, taking the derivatives of an objective function and a constraint function with respect to the optimized variables as follows:

$$\begin{matrix}\frac{\partial C}{\partial {P}_{i}} = - T \frac{\partial K}{\partial {P}_{i}} T = - \frac{1}{8} {\sum }_{k = 1}^{{n}_{s}} {T}_{k}^{T} ( {\sum }_{j = 1}^{{n}_{b}} \frac{\partial {λ}_{kj}}{\partial {ξ}_{kj}} {\sum }_{l = 1}^{8} \frac{\partial H ( {Φ}_{l}^{kj} )}{\partial {P}_{i}} ) {K}^{0} {T}_{k} , & ( 1.21 ) \\ \frac{\partial V}{\partial {P}_{i}} = \frac{1}{8} {\sum }_{j = 1}^{{N}_{b}} {\sum }_{l = 1}^{8} \frac{\partial H ( {Φ}_{l}^{kj} )}{\partial {P}_{i}} {v}_{b} , & ( 1.22 ) \\ \frac{\partial G}{\partial {P}_{i}} = \frac{1}{‖ Ω ‖} {\sum }_{j = 1}^{{n}_{l}} {L}^{′} ( ∇ {G}_{j} ) \frac{\partial ∇ {G}_{j}}{\partial {P}_{i}} {v}_{{Ω}_{j}} , & ( 1.23 ) \\ \frac{\partial ∇ {G}_{j}}{\partial {P}_{i}} = \frac{1}{{N}_{b}^{j} {\overline{g}}_{j}} {( \frac{1}{{N}_{b}^{j}} {\sum }_{s = 1}^{{N}_{b}^{j}} {‖ ∇ {P}_{s}^{j} ‖}^{p} )}^{\frac{1}{p} - 1} {\sum }_{s = 1}^{{N}_{b}^{j}} {‖ ∇ {P}_{s}^{j} ‖}^{p - 1} \frac{‖ ∇ {P}_{s}^{j} ‖}{\partial {P}_{i}} , & ( 1.24 )\end{matrix}$$

wherein

$$\frac{\partial C}{\partial {P}_{i}} , \frac{\partial V}{\partial {P}_{i}} and \frac{\partial G}{\partial {P}_{i}}$$

are respectively equations of taking partial derivatives of the parametric variable Pᵢ for the objective function, the volume constraint and the gradient constraint;

$$\frac{\partial ∇ {G}_{j}}{\partial {P}_{i}}$$

is an intermediate equation to be calculated in the process of taking the partial derivative of the gradient; nₛ is the number of the coarse units, and n_{b} is the number of the fine units in each coarse unit; Φₗ^{kj} is the Φ function value of the lth node in the kth coarse unit and the jth thin unit; from the material thermal conductivity formula

$$λ = \frac{{λ}_{S} \cdot {λ}_{D}}{ξ \cdot ( {λ}_{D} - {λ}_{S} ) + {λ}_{S}} ,$$

is a parametric ξ factor corresponding to the material thermal conductivity λₖⱼ in the kth coarse unit and the jth fine unit; K⁰ is an initial stiffness matrix. In an MMA solver, an optimized porous structure with steady period change can be obtained through

$$\frac{\partial C}{\partial {P}_{i}} , \frac{\partial V}{\partial {P}_{i}} and \frac{\partial G}{\partial {P}_{i}} .$$

Because the wall-thickness function W(r) is fixed and the porosity of the structure is increased with the increase of the period function P(r) on the whole, the convergence of period optimization is easily realized. In our experiment, the period optimization converges on 70 iterations.

Step 2: wall-thickness optimization; similarly, based on the control point of W(r) (variable is {Wᵢ}ᵢ₌₁ⁿ^{ₜ}), constructing the wall-thickness function W(r) through the RBF interpolation method, with corresponding sensitive analysis as follows:

$$\begin{matrix}\frac{\partial C}{\partial {W}_{i}} = - T \frac{\partial K}{\partial {P}_{i}} T = - \frac{1}{8} {\sum }_{k = 1}^{{n}_{s}} {T}_{k}^{T} ( {\sum }_{j = 1}^{{n}_{b}} \frac{\partial {λ}_{kj}}{\partial {ξ}_{kj}} {\sum }_{l = 1}^{8} \frac{\partial H ( {Φ}_{l}^{kj} )}{\partial {W}_{i}} ) {K}^{0} {T}_{k} , & ( 1.25 ) \\ \frac{\partial V}{\partial {W}_{i}} = \frac{1}{8} {\sum }_{j = 1}^{{N}_{b}} {\sum }_{l = 1}^{8} \frac{\partial H ( {Φ}_{l}^{kj} )}{\partial {W}_{i}} {v}_{b} , & ( 1.26 )\end{matrix}$$

wherein

$$\frac{\partial C}{\partial {W}_{i}} and \frac{\partial V}{\partial {W}_{i}}$$

are respectively equations of taking the partial derivatives of the parametric variable Wᵢ for the objective function and the volume constraint; Φₗ^{kj} is the Φ function value of the lth node in the kth coarse unit and the jth thin unit; ξₖⱼ is a parametric factor corresponding to the material thermal conductivity λₖⱼ in the kth coarse unit and the jth fine unit. The gradient constraint of W(r) is not needed because the wall-thickness change is steadier than the period change. Finally,

$$\frac{\partial C}{\partial {W}_{i}} and \frac{\partial V}{\partial {W}_{i}}$$

are selected from the MMA solver to obtain the optimized porous structure with smooth period and wall-thickness change. Because the optimized period function P(r) is fixed and the porosity of the structure is monotonously increased with the increase of the wall-thickness function W(r), the convergence of wall-thickness optimization is also easily realized. In the experiment, the wall-thickness optimization converges on 30 iterations.

The design and optimization system of the porous shell structure for heat dissipation for 3D printing in the present invention belongs to the field of computer-aided design and industrial design and manufacturing. The proposed porous structure is presented in the form of the implicit function and has good connectivity, controllability, mechanical property, thermal property, high surface area-to-volume ratio and high smoothness. The proposed porous structure is applied to the 3D heat dissipation problem to obtain an optimized porous structure with continuous geometric change and smooth topological change. Compared with the existing traditional heat dissipation structure, the porous structure greatly improves the heat dissipation performance, and efficiency and effectiveness of heat conduction. The porous structure designed by the present invention has the characteristics of smoothness, full connectivity and quasi-self-supporting to ensure the applicability and the manufacturability of this structure. This porous structure is suitable for the frequently-used 3D printing manufacturing methods. The internal structure in the printing process does not need additional support, which can save printing time and printing material.

### DESCRIPTION OF DRAWINGS

FIG. 1 is a flow chart of design and optimization of a porous structure for 3D heat dissipation based on triply periodic minimal surface (TPMS).

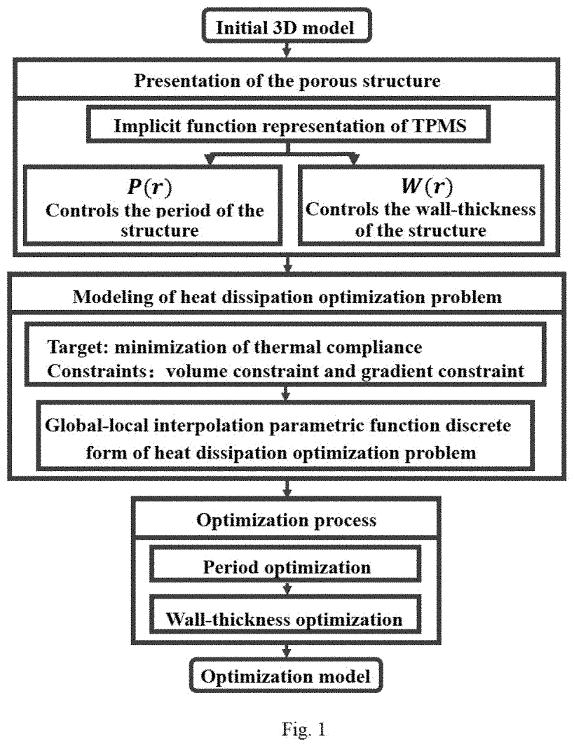

FIG. 2 is a result diagram of design and optimization of a porous structure for 3D heat dissipation based on TPMS.

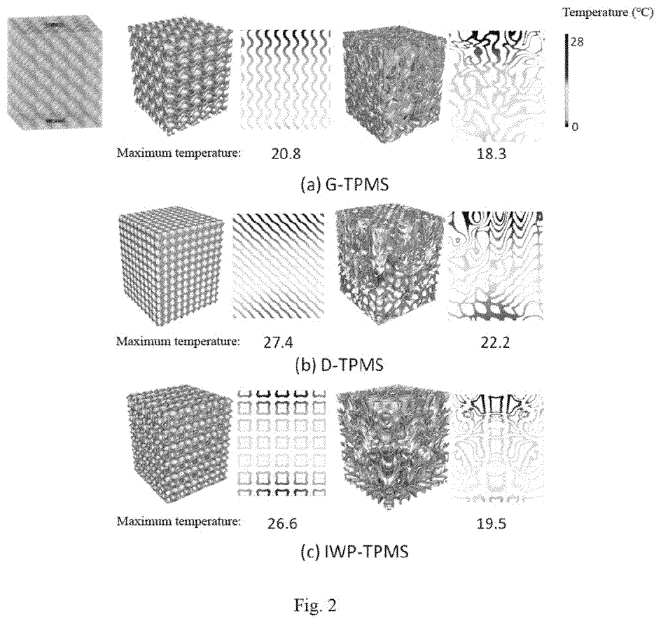

### DETAILED DESCRIPTION

Specific embodiments of the present invention are further described below in combination with accompanying drawings and the technical solution.

The implementation of the present invention can be specifically divided into the main steps of function presentation of the porous shell structure, establishment of the optimization model of the heat dissipation problem and discretization, and the optimization process.

### (I) Presentation of a Porous Shell Structure

Firstly, an improved implicit function surface is established:

$${φ}^{0} = P ( r ) \cdot φ ( \frac{r}{P ( r )} ) = 0 \qquad ( 2.1 )$$

wherein r is a 3D vector; x, y and z are respectively corresponding coordinates; P(r) controls the continuous change of a pore period; and a porous surface with smooth transition in space is constructed.

Then, a multi-scale porous shell structure with thickness is constructed: a porous structure with thickness based on TPMS can be obtained by offsetting the improved implicit function surface to both sides through a parametric function W(r) controlling the wall-thickness; and two offset surfaces are presented as:

$$\begin{matrix}{φ}^{W} ( r ) = P ( r ) \cdot φ ( \frac{r}{P ( r )} ) - W ( r ) = 0 & ( 2.2 ) \\ {φ}^{- W} ( r ) = P ( r ) \cdot φ ( \frac{r}{P ( r )} ) + W ( r ) = 0 & ( 2.3 )\end{matrix}$$

Finally, the porous shell structure based on TPMS is obtained:

Φ(r)=−φ^{W}(r)+φ^{-W}(r)−\sqrt{φ^{W}(r)²+φ^{-W}(r)²} (2.4)

In conclusion, P(r) (the value range of P surface is [0.5, 2], the value range of G surface is [0.37, 2], the value range of D surface is [0.5, 2] and the value range of IWP surface is [0.48, 2]) controls the period of the porous structure; and W(r) (the value range of P surface is [0.02,0.95], the value range of G surface is [0.02,1.35], the value range of D surface is [0.02,0.7] and the value range of IWP surface is [0.02,2.95]) controls the wall-thickness of the porous structure.

### (II) Modeling and Optimization Based on the Porous Shell Structure

1. Modeling of Heat Dissipation Problem

The optimization problem of the porous structure is established by using the minimization problem of thermal compliance. That is, by taking minimization of the average temperature of the structure as a target and taking the model volume and the boundary conditions as the constraints, the internal space of the model is filled by the constructed porous shell structure so that the period and the wall-thickness of the porous structure have optimized distribution under the given volume constraint of the material.

Based on the above purpose, a problem model is established as follows:

$$\begin{matrix}min \\ P ( r ) , W ( r )\end{matrix} C = {\int }_{{Γ}_{Q}}^{ } H ( Φ ) {q}_{s} T d Γ + {\int }_{Ω}^{ } Q T d Ω \qquad ( 2.5 )$$

### Then:

∫_{Ω}H(Φ)λ∇T^{T}∇ωdΩ=∫_{Γ}_{_{Q}}H(Φ)ωgₛdΓ+∫_{Ω}ωQdΩ+∫_{Γ}_{_{T}}H(Φ)λ∇T̅ωdΓ, (2.6)

V=∫H(Φ)dΩ≤v̅, (2.7)

∥∇P(r)∥≤g̅, (2.8)

wherein C is thermal compliance, T is a temperature field, Ω is a given design domain, Φ is the function presentation of the porous shell structure given above, Q is a heat flux of an internal heat generation term, qₛ is a heat flux along a normal direction on a Neumann boundary Γ_{Q}, T̅ is a given temperature on a Direchlet boundary and λ is material thermal conductivity; ∇ is a vector differential operator,

$$∇ = \frac{\partial }{\partial x} X + \frac{\partial }{\partial y} Y + \frac{\partial }{\partial z} Z ;$$

X, Y and Z respectively present unit vectors along the positive directions of three coordinate axes x, y and z; ω∈ [symbol] is a corresponding test function; [symbol] ={ω|ω∈Sob¹(Ω), ω=0 on Γ_{T}}; Sob¹ is a first-order Sobolev space; V is the volume of the porous structure; v̅ is a corresponding volume constraint; to prevent the severe change of the period function from damaging the porous structure, the gradient constraint g̅ of the period change is added; a computing formula of modules of gradients is

$$∇ P ( r ) = \sqrt{{( \frac{\partial P ( r )}{\partial x} )}^{2} + {( \frac{\partial P ( r )}{\partial y} )}^{2} + {( \frac{\partial P ( r )}{\partial z} )}^{2}} ;$$

H(x) is Heaviside function; when x is negative, H(x)=0, otherwise, is 1; to make the optimization problem differentiable and avoid a check board phenomenon, H(x) is defined as a continuous function H_{η}(x) which is defined as:

$${H}_{η} ( x ) = \{ \begin{matrix}1 , & if x > η , \\ \frac{3}{4} ( \frac{x}{η} - \frac{{x}^{3}}{3 {η}^{3}} ) + \frac{1}{2} , & if - η \leq x \leq η , \\ 0 , & if x < - η\end{matrix} , \qquad ( 2.9 )$$

wherein η is a regularization parameter used for controlling the number of non-singularity elements in a global stiffness matrix, and the interval of intermediate values is generally defined by the parameter η=10⁻³. In addition, the material thermal conductivity λ of the porous structure is calculated by the structure function Φ, and shall be set as

$$λ = \frac{{λ}_{S} \cdot {λ}_{D}}{ξ \cdot ( {λ}_{D} - {λ}_{S} ) + {λ}_{S}} ;$$

ξ=H(Φ) is the volume ratio of solid material; and λ_{S} and λ_{D} present the material thermal conductivity of the solid material and the pore part respectively.

2. Discretization of Optimization Problem

The solution domain is subdivided into two sets of uniform meshes with different accuracy in the discretization process: the coarse meshes are used to interpolate the temperature field and the fine meshes are used to describe the model and perform integral calculation.

The discrete form of the optimization problem is obtained:

$$\begin{matrix}min \\ P ( r ) , W ( r )\end{matrix} C = {Q}^{T} T \qquad ( 2.10 )$$

### Then:

$$\begin{matrix}KT = Q & ( 2.11 ) \\ V = \frac{1}{8} {\sum }_{i = 1}^{{N}_{b}} {\sum }_{l = 1}^{8} {H}_{η} ( {Φ}_{l}^{j} ) {v}_{b} \leq \overline{v} , & ( 2.12 ) \\ G = \frac{1}{‖ Ω ‖} {\sum }_{i = 1}^{{n}_{l}} L ( \frac{{( {\sum }_{s = 1}^{{N}_{b}^{i}} {‖ ∇ {P}_{s}^{i} ‖}^{p} )}^{\frac{1}{p}}}{{\overline{g}}_{i}} - 1 ) {v}_{{Ω}_{i}} \leq 0 , & ( 2.13 )\end{matrix}$$

wherein T is the temperature field; Q is the thermal source and heat flux term; K is a stiffness matrix; V is the volume of the porous structure; v̅ is the corresponding volume constraint; N_{b}=n_{b}×nₛ is the total number of the fine units; Φᵢ^{j} is the Φ function value of the lth node in the jth fine unit; v_{b} is the volume of fine mesh units; G is the total gradient constraint of the structure; ∥Ω∥ is the volume of Ω; nₗ is the number of sub-domains in the design domain; N_{b}ⁱ is the number of the fine units in the ith sub-domain Ωᵢ; ∇Pₛⁱ is the gradient of the period function at the point i in the sth fine unit; g̅ᵢ is a local gradient constraint value in the ith sub-domain Ωᵢ; v_{Ω}_{ᵢ} is the volume of the ith coarse mesh unit; p>0 is the penalty factor of the global gradient constraint, and moreover:

$$L ( x ) = \{ \begin{matrix}{x}^{2} , & if x \geq 0 , \\ 0 , & if x < 0\end{matrix} .$$

The optimization of the period parametric function and the thickness parametric function is converted into the optimization of a finite number of design variables by using a global-local RBF interpolation algorithm. The global-local RBF interpolation can be simplified as follows:

P(r)=Σᵢ₌₁ⁿ^{ₜ}Nᵢ(r)Pᵢ, (2.14)

W(r)=Σᵢ₌₁ⁿ^{ₜ}Nᵢ(r)Wᵢ, (2.15)

wherein nₜ is the total number (which is 400) of control points in the design domain Ω; Nᵢ(r) is a corresponding computable coefficient function; {Pᵢ}ᵢ₌₁ⁿ^{ₜ} is the period function value of the control points; and {Pᵢ}ᵢ₌₁ⁿ^{ₜ} is the wall-thickness function value of the control points. Because the positions of the control points are not changed in the optimization process, the coefficient function Nᵢ (r) can be calculated in advance before optimization.

3. Optimization of Modeling Problem

Only two unknown parametric functions P(r) and W(r) need to be optimized. The specific optimization process is as follows:

Step 1: period optimization; firstly, converting the function optimization into the optimization of interpolation basis function parameters through the RBF interpolation method; randomly selecting nₜ interpolation basis points {Oᵢ}ᵢ₌₁ⁿ^{ₜ} from the solution domain, and then obtaining an interpolation form of (2.14); thus, converting the problem of period optimization into the problem of optimization of the parametric variable {Pᵢ}ᵢ₌₁ⁿ^{ₜ}; finally, taking the derivatives of an objective function and a constraint function with respect to the optimized variables as follows:

$$\begin{matrix}\frac{\partial C}{\partial {P}_{i}} = - T \frac{\partial K}{\partial {P}_{i}} T = - \frac{1}{8} {\sum }_{k = 1}^{{n}_{s}} {T}_{k}^{T} ( {\sum }_{j = 1}^{{n}_{b}} \frac{\partial {λ}_{kj}}{\partial {ξ}_{kj}} {\sum }_{l = 1}^{8} \frac{\partial H ( {Φ}_{l}^{kj} )}{\partial {P}_{i}} ) {K}^{0} {T}_{k} , & ( 2.16 ) \\ \frac{\partial V}{\partial {P}_{i}} = \frac{1}{8} {\sum }_{j = 1}^{{N}_{b}} {\sum }_{l = 1}^{8} \frac{\partial H ( {Φ}_{l}^{kj} )}{\partial {P}_{i}} {v}_{b} , & ( 2.17 ) \\ \frac{\partial G}{\partial {P}_{i}} = \frac{1}{‖ Ω ‖} {\sum }_{j = 1}^{{n}_{l}} {L}^{′} ( ∇ {G}_{j} ) \frac{\partial ∇ {G}_{j}}{\partial {P}_{i}} {v}_{{Ω}_{j}} , & ( 2.18 ) \\ \frac{\partial ∇ {G}_{j}}{\partial {P}_{i}} = \frac{1}{{N}_{b}^{j} {\overline{g}}_{j}} {( \frac{1}{{N}_{b}^{j}} {\sum }_{s = 1}^{{N}_{b}^{j}} {‖ ∇ {P}_{s}^{j} ‖}^{p} )}^{\frac{1}{p} - 1} {\sum }_{s = 1}^{{N}_{b}^{j}} {‖ ∇ {P}_{s}^{j} ‖}^{p - 1} \frac{\partial ‖ ∇ {P}_{s}^{j} ‖}{\partial {P}_{i}} , & ( 2.19 )\end{matrix}$$

wherein

$$\frac{\partial C}{\partial {P}_{i}} , \frac{\partial V}{\partial {P}_{i}} and \frac{\partial G}{\partial {P}_{i}}$$

are respectively equations of taking partial derivatives of the parametric variable Pᵢ for the objective function, the volume constraint and the gradient constraint;

$$\frac{\partial ∇ {G}_{j}}{\partial {P}_{i}}$$

is an intermediate equation to be calculated in the process of taking the partial derivative of the gradient; nₛ is the number of the coarse units, and n_{b} is the number of the fine units in each coarse unit; Φₗ^{kj} is the Φ function value of the lth node in the kth coarse unit and the jth thin unit; from the material thermal conductivity formula

$$λ = \frac{{λ}_{S} \cdot {λ}_{D}}{ξ \cdot ( {λ}_{D} - {λ}_{S} ) + {λ}_{S}} ,$$

ξₖⱼ is a parametric factor ξ corresponding to the material thermal conductivity λₖⱼ in the kth coarse unit and the jth fine unit; K⁰ is an initial stiffness matrix. Under the given sensitive analysis of the variables, the optimized period parametric function can be obtained by the well-known MMA method to obtain the structure after period optimization and serve as the initial structure of wall-thickness optimization.

Step 2: wall-thickness optimization; similarly, based on the control point of W(r) (variable is {Wᵢ}ᵢ₌₁ⁿ^{ₜ}), constructing the wall-thickness function W(r) through the RBF interpolation method, with corresponding sensitive analysis as follows:

$$\begin{matrix}\frac{\partial C}{\partial {W}_{i}} = - T \frac{\partial K}{\partial {P}_{i}} T = - \frac{1}{8} {\sum }_{k = 1}^{{n}_{s}} {T}_{k}^{T} ( {\sum }_{j = 1}^{{n}_{b}} \frac{\partial {λ}_{kj}}{\partial {ξ}_{kj}} {\sum }_{l = 1}^{8} \frac{\partial H ( {Φ}_{l}^{kj} )}{\partial {W}_{i}} ) {K}^{0} {T}_{k} , & ( 2.20 ) \\ \frac{\partial V}{\partial {W}_{i}} = \frac{1}{8} {\sum }_{j = 1}^{{N}_{b}} {\sum }_{l = 1}^{8} \frac{\partial ( {Φ}_{l}^{kj} )}{\partial {W}_{i}} {v}_{b} , & ( 2.21 )\end{matrix}$$

wherein

$$\frac{\partial C}{\partial {W}_{i}} and \frac{\partial V}{\partial {W}_{i}}$$

are respectively equations of taking the partial derivatives of the parametric variable Wᵢ for the objective function and the volume constraint; Φₗ^{kj} is the Φ function value of the lth node in the kth coarse unit and the jth thin unit; ξₖⱼ is a parametric factor corresponding to the material thermal conductivity λₖⱼ in the kth coarse unit and the jth fine unit. The solution of the optimization problem is finally obtained by substituting into an MMA algorithm.

The design and optimization of the heat dissipation structure for porous structure presentation based on TPMS are proposed. The porous structure is presented in the form of the implicit function and has good connectivity, controllability, high surface-to-volume ratio, high smoothness, good mechanical property and good thermal property. Various experiments show that the proposed porous structure greatly improves the heat dissipation performance, and efficiency and effectiveness of heat conduction. In order to obtain high heat conduction efficiency, the balance is achieved between the period and the wall-thickness under the given volume constraint; and the change of the period and the wall-thickness of the optimized structure is smooth and natural, which is conducive to structural stress and manufacturing. Compared with the traditional heat dissipation structure and mesh structure, the optimized porous structure has higher heat dissipation efficiency (lower thermal compliance).

1. A design and optimization method of a porous structure for 3D heat dissipation based on triply periodic minimal surface (TPMS), comprising the following steps:
(I) presentation of the porous structure
TPMSs have implicit function presentation, and the implicit function presentation of P-TPMS is as follows:
φₚ(r)=cos(2π·x)+cos(2π·y)+cos(2π·z)=0 (1.1)
wherein r is a 3D vector and x, y and z are respectively corresponding coordinates;
directly adding a period parametric function P(r)>0 to function presentation of TPMS; to maintain the value scaling of a signed distance field (SDF) in the process of period change, improving an implicit function, presented as:
$${φ}^{0} = P ( r ) \cdot φ ( \frac{r}{P ( r )} ) = 0 \qquad ( 1.2 )$$
wherein P(r) controls the continuous change of a pore period, and a porous surface with smooth transition in space is constructed; other types of TPMSs are processed according to the same method;
obtaining a porous structure with thickness based on TPMS by offsetting the improved implicit function surface φ⁰ to both sides through the parametric function W(r) controlling the wall-thickness; and presenting two offset surfaces as:
$$\begin{matrix}{φ}^{W} ( r ) = P ( r ) \cdot φ ( \frac{r}{P ( r )} ) - W ( r ) = 0 & ( 1.3 ) \\ {φ}^{- W} ( r ) = P ( r ) \cdot φ ( \frac{r}{P ( r )} ) + W ( r ) = 0 & ( 1.4 )\end{matrix}$$
finally, presenting a porous shell structure based on TPMS through functions using intersection operator:
Φ(r)=−φ^{W}(r)+φ^{-W}(r)−\sqrt{φ^{W}(r)²+φ^{-W}(r)²} (1.5)
in the above definition, introducing the parametric function P(r)>0 controlling the period and the parametric function W(r)>0 controlling the wall-thickness to control the shape and period pores of the porous structure, and finally generating the porous structure with wall-thickness which satisfies the demands through the optimized parametric functions P(r) and W(r);
(II) optimization process of heat dissipation problem
for the heat dissipation problem under steady-state heat conduction conditions, filling the internal space of the model by the constructed porous shell structure after the thermal source and boundary conditions of the model are given, and calculating the optimized distribution of the period and wall-thickness of the porous structure under the given volume constraint of the material and the gradient constraint of the period function;
(1) establishment of problem model
establishing a heat dissipation problem model as follows:
$$\begin{matrix}min \\ P ( r ) , W ( r )\end{matrix} C = {\int }_{{Γ}_{Q}} H ( Φ ) {q}_{s} Td Γ + {\int }_{Ω}^{ } QTd Ω \qquad ( 1.6 )$$
then:
∫_{Ω}H(Φ)λ∇T∇ωdΩ=∫_{Γ}_{_{Q}}H(Φ)ω^{T}qₛdΓ+ω^{T}QdΩ+∫_{Γ}_{_{T}}λ∇T̅ωdΓ, (1.7)
V=∫H(Φ)dΩ≤v̅, (1.8)
∥∇P(r)∥g̅, (1.9)
wherein C is thermal compliance, T is a temperature field, Ω is a given design domain, Φ is the function presentation of the porous shell structure given above, Q is a heat flux of an internal heat generation term, qₛ is a heat flux along a normal direction on a Neumann boundary Γ_{Q}, T̅ is a given temperature on a Direchlet boundary and λ is material thermal conductivity; ∇ is a vector differential operator,
$$∇ = \frac{\partial }{\partial x} X + \frac{\partial }{\partial y} Y + \frac{\partial }{\partial z} Z ;$$
X, Y and Z respectively present unit vectors along the positive directions of three coordinate axes x, y and z; ω∈ [symbol] is a corresponding test function; [symbol] ={ω|ω∈Sob¹(Ω), ω=0 on Γ_{T}}; Sob¹ is a first-order Sobolev space; V is the volume of the porous structure; v̅ is a corresponding volume constraint; to prevent the severe change of the period function from damaging the porous structure, the gradient constraint g̅ of the period change is added; a computing formula of modules of gradients is
$$∇ P ( r ) = \sqrt{{( \frac{\partial P ( r )}{\partial x} )}^{2} + {( \frac{\partial P ( r )}{\partial y} )}^{2} + {( \frac{\partial P ( r )}{\partial z} )}^{2}} ;$$
H(x) is Heaviside function; when x is negative, H(x)=0, otherwise, is 1; to make the optimization problem differentiable and avoid a check board phenomenon, H(x) is defined as a continuous function H_{η}(x) which is defined as:
$${H}_{η} ( x ) = \{ \begin{matrix}1 , & if x > η , \\ \frac{3}{4} ( \frac{x}{η} - \frac{{x}^{3}}{3 {η}^{3}} ) + \frac{1}{2} , & if - η \leq x \leq η , \\ 0 , & if x < - η\end{matrix} , \qquad ( 1.10$$
wherein η is a regularization parameter used for controlling the number of non-singularity elements in a global stiffness matrix, and the interval of intermediate values is defined by the parameter η=10⁻³; in addition, the material thermal conductivity λ of the porous structure is calculated by the structure function Φ, and set as
$$λ = \frac{{λ}_{S} \cdot {λ}_{D}}{ξ \cdot ( {λ}_{D} - {λ}_{S} ) + {λ}_{S}} ;$$
ξ=H(Φ) is the volume ratio of solid material; and λ_{S} and λ_{D} present the material thermal conductivity of the solid material and the pore part respectively;
(2) discretization
subdividing a solution domain into two sets of uniform meshes with different accuracy in the discretization process: using coarse meshes to interpolate the temperature field and using fine meshes to describe the model and perform integral calculation; setting the number of coarse units as nₛ and setting the number n_{b} of fine units in each coarse unit as 27 by default; obtaining the discrete form of the optimization problem (1.6-1.9):
$$\begin{matrix}min \\ P ( r ) , W ( r )\end{matrix} C = {Q}^{T} T \qquad ( 1.11 )$$
then:
$$\begin{matrix}KT = Q & ( 1.12 ) \\ V = \frac{1}{8} {\sum }_{i = 1}^{{N}_{b}} {\sum }_{l = 1}^{8} {H}_{η} ( {ϕ}_{l}^{j} ) {v}_{b} \leq \overline{v} , & ( 1.13 ) \\ G = \frac{1}{‖ Ω ‖} {\sum }_{i = 1}^{{n}_{l}} L ( \frac{{( {\sum }_{s = 1}^{{N}_{b}^{i}} {‖ ∇ {P}_{s}^{i} ‖}^{p} )}^{\frac{1}{p}}}{{\overline{g}}_{i}} - 1 ) {v}_{{Ω}_{i}} \leq 0 , & ( 1.14 )\end{matrix}$$
wherein T is the temperature field; Q is the thermal source and heat flux term; K is a stiffness matrix; V is the volume of the porous structure; v̅ is the corresponding volume constraint; N_{b}=n_{b}×nₛ is the total number of the fine units; Φₗ^{j} is the Φ function value of the lth node in the jth fine unit; v_{b} is the volume of fine mesh units; G is the total gradient constraint of the structure; ∥Ω∥ is the volume of Ω; nᵢ is the number of sub-domains in the design domain; N_{b}ⁱ is the number of the fine units in the ith sub-domain Ωᵢ; ∇Pₛⁱ is the gradient of the period function at the point i in the sth fine unit; g̅ᵢ is a local gradient constraint value in the ith sub-domain Ωᵢ; v_{Ω}_{ᵢ} is the volume of the ith coarse mesh unit; p>0 is the penalty factor of the global gradient constraint, and moreover:
$$L ( x ) = \{ \begin{matrix}{x}^{2} , & if x \geq 0 , \\ 0 , & if x < 0\end{matrix} . \qquad ( 1.15 )$$
(3) global-local interpolation
converting the optimization of the period parametric function and the thickness parametric function into the optimization of a finite number of design variables by using a global-local radial basis function (RBF) interpolation algorithm, with the key idea to decompose a large coefficient matrix into smaller coefficient matrices with weights for calculation;
for the period parametric function, firstly, dividing Ω into nᵢ sub-domains {Qᵢ}ᵢ₌₁ⁿ^{ₗ}, and performing radial basis function (RBF) interpolation in local ellipsoids comprising corresponding sub-domains to obtain a local period parametric function:
$$\begin{matrix}P ( r ) = {\sum }_{k = 1}^{{n}_{l}} \frac{{ω}_{k} ( r )}{{\sum }_{j = 1}^{{n}_{l}} {ω}_{j} ( r )} {P}_{k} ( r ) = {\sum }_{k = 1}^{{n}_{l}} {ψ}_{k} ( r ) {P}_{k} ( r ) , & ( 1.16 ) \\ {ω}_{k} ( r ) = {( \frac{{( {R}_{k} ( r ) - {d}_{k} ( r ) )}_{+}}{{R}_{k} ( r ) \cdot {d}_{k} ( r )} )}^{2} , & ( 1.17 )\end{matrix}$$
wherein ψₖ(r) is a weight parameter defined by ωₖ(r); dₖ(r)=∥r−Cₖ∥₂ is a distance between an interpolation point and an ellipsoid center point Cₖ; (*)₊ is (x)₊=x when a truncation function satisfies x>0, otherwise (x)₊=0; Rₖ(r) is a length function of the radius; Pₖ (r) is the local period parametric function corresponding to the sub-domain Ωₖ in the local ellipsoids and is defined as:
Pₖ(r)=Σᵢ₌₁ⁿ^{ₖₜ}Rₖᵢ(r)aₖᵢ+Σⱼ₌₁^{m}qₖⱼ(r)bₖⱼ, (1.18)
wherein Rₖᵢ(r)=(r−Oₖᵢ)² log(|r−Oₖᵢ|) is a thin plate radial basis function; {Oₖᵢ}ᵢ₌₁ⁿ^{ₖₜ} is a control point corresponding to the sub-domain Ωₖ in the local ellipsoids; qₖᵢ(r) is a primary term of coordinates x, y and z; aₖᵢ and bₖⱼ are undetermined coefficients of a quadratic term and the primary term respectively; and m is the number of the primary terms, m=4;
simplifying the global-local RBF interpolation as follows:
P(r)=Σᵢ₌₁ⁿ^{ₜ}Nᵢ(r)Pᵢ, (1.19)
wherein nₜ is the total number of control points in the design domain Ω, which is 400; Nᵢ(r) is a corresponding coefficient function; and {P₁}ᵢ₌₁ⁿ^{ₜ} is the period function value of the control points;
(4) optimization of modeling problem
the 3D heat dissipation optimization method proposed based on the above constructed optimization problem comprises two parts of period optimization and wall-thickness optimization; the period and the wall-thickness of the porous structure based on TPMS are independently controlled by the period function P(r) and the wall-thickness function W(r) respectively; the period optimization is coarse adjustment of the structure, and the wall-thickness optimization is fine adjustment; a specific optimization process is as follows:
step 1: period optimization; firstly, converting the function optimization into the optimization of interpolation basis function parameters through the RBF interpolation method; randomly selecting nₜ interpolation basis points {Oᵢ}ᵢ₌₁ⁿ^{ₜ} from the solution domain, and then obtaining an interpolation form:
P(r)=Σᵢ₌₁ⁿ^{ₜ}Nᵢ(r)Pᵢ, (1.20)
converting the problem of period optimization into the problem of optimization of the parametric variable {Pᵢ}ᵢ₌₁ⁿ^{ₜ}; finally, taking the derivatives of an objective function and a constraint function with respect to the optimized variables as follows:
$$\begin{matrix}\frac{\partial C}{\partial {P}_{i}} = - T \frac{\partial K}{\partial {P}_{i}} T = - \frac{1}{8} {\sum }_{k = 1}^{{n}_{s}} {T}_{k}^{T} ( {\sum }_{j = 1}^{{n}_{b}} \frac{\partial {λ}_{kj}}{\partial {ξ}_{kj}} {\sum }_{l = 1}^{8} \frac{\partial H ( {Φ}_{l}^{kj} )}{\partial {P}_{i}} ) {K}^{0} {T}_{k} , & ( 1.121 ) \\ \frac{\partial V}{\partial {P}_{i}} = \frac{1}{8} {\sum }_{j = 1}^{{N}_{b}} {\sum }_{l = 1}^{8} \frac{\partial H ( {Φ}_{l}^{kj} )}{\partial {P}_{i}} {v}_{b} , & ( 1.22 ) \\ \frac{\partial G}{\partial {P}_{i}} = \frac{1}{‖ Ω ‖} {\sum }_{j = 1}^{{n}_{l}} {L}^{′} ( ∇ {G}_{j} ) \frac{\partial ∇ {G}_{j}}{\partial {P}_{i}} {v}_{{Ω}_{j}} , & ( 1.23 ) \\ \frac{\partial ∇ {G}_{j}}{\partial {P}_{i}} = \frac{1}{{N}_{b}^{j} {\overline{g}}_{j}} {( \frac{1}{{N}_{b}^{j}} {\sum }_{s = 1}^{{N}_{b}^{j}} {‖ ∇ {P}_{s}^{j} ‖}^{p} )}^{\frac{1}{p} - 1} {\sum }_{s = 1}^{{N}_{b}^{j}} {‖ ∇ {P}_{s}^{j} ‖}^{p - 1} \frac{\partial ‖ ∇ {P}_{s}^{j} ‖}{\partial {P}_{i}} , & ( 1.24 )\end{matrix}$$
wherein
$$\frac{\partial C}{\partial {P}_{i}} , \frac{\partial V}{\partial {P}_{i}} and \frac{\partial G}{\partial {P}_{i}}$$
are respectively equations of taking partial derivatives of the parametric variable Pᵢ for the objective function, the volume constraint and the gradient constraint;
$$\frac{\partial ∇ {G}_{j}}{\partial {P}_{i}}$$
is an intermediate equation to be calculated in the process of taking the partial derivative of the gradient; nₛ is the number of the coarse units, and n_{b} is the number of the fine units in each coarse unit; Φₗ^{kj} is the Φ function value of the lth node in the kth coarse unit and the jth thin unit; from the material thermal conductivity formula
$$λ = \frac{{λ}_{S} \cdot {λ}_{D}}{ξ \cdot ( {λ}_{D} - {λ}_{S} ) + {λ}_{S}} , {ξ}_{kj}$$
is a parametric factor ξ corresponding to the material thermal conductivity λₖⱼ in the kth coarse unit and the jth fine unit; K⁰ is an initial stiffness matrix; in an MMA solver, an optimized porous structure with steady period change is obtained through
$$\frac{\partial C}{\partial {P}_{i}} , \frac{\partial V}{\partial {P}_{i}} and \frac{\partial G}{\partial {P}_{i}} ;$$
step 2: wall-thickness optimization; similarly, based on the control point of W(r) with a variable of {Wᵢ}ᵢ₌₁ⁿ^{ₜ}, constructing the wall-thickness function W(r) through the RBF interpolation method, with corresponding sensitive analysis as follows:
$$\begin{matrix}\frac{\partial C}{\partial {W}_{i}} = - T \frac{\partial K}{\partial {P}_{i}} T = - \frac{1}{8} {\sum }_{k = 1}^{{n}_{s}} {T}_{k}^{T} ( {\sum }_{j = 1}^{{n}_{b}} \frac{\partial {λ}_{kj}}{\partial {ξ}_{kj}} {\sum }_{l = 1}^{8} \frac{\partial H ( {Φ}_{l}^{kj} )}{\partial {W}_{i}} ) {K}^{0} {T}_{k} , & ( 1.25 ) \\ \frac{\partial V}{\partial {W}_{i}} = \frac{1}{8} {\sum }_{j = 1}^{{N}_{b}} {\sum }_{l = 1}^{8} \frac{\partial H ( {Φ}_{l}^{kj} )}{\partial {W}_{i}} {v}_{b} , & ( 1.26 )\end{matrix}$$
wherein
$$\frac{\partial C}{\partial {W}_{i}} and \frac{\partial V}{\partial {W}_{i}}$$
are respectively equations of taking the partial derivatives of the parametric variable Wᵢ for the objective function and the volume constraint; Φₗ^{kj} is the Φ function value of the lth node in the kth coarse unit and the jth thin unit; ξₖⱼ is a parametric factor corresponding to the material thermal conductivity λₖⱼ in the kth coarse unit and the jth fine unit; the gradient constraint of W(r) is not needed because the wall-thickness change is steadier than the period change; and finally,
$$\frac{\partial C}{\partial {W}_{i}} and \frac{\partial V}{\partial {W}_{i}}$$
are selected from the MMA solver to obtain the optimized porous structure with smooth period and wall-thickness change.
